(19) United States
(12) Patent Application Publication
(10) Pub. No.: US 2026/0100294 A1
(43) Pub. Date: Apr. 9, 2026

(54) LEAD FREE CABLE FOR POWER DELIVERY TO DOWNHOLE EQUIPMENT

(71) Applicant: Halliburton Energy Services, Inc., Houston, TX (US)

(72) Inventor: Hassan Mansir, Frimley (GB)

(21) Appl. No.: 18/966,958

(22) Filed: Dec. 3, 2024

Related U.S. Application Data
(60) Provisional application No. 63/704,679, filed on Oct. 8, 2024.

(51) Int. Cl. H01B 7/02; E21B 17/00; H01B 13/06

(52) U.S. Cl. CPC H01B 7/0225; E21B 17/003; H01B 13/06

(57) ABSTRACT

Some implementations include a downhole electrical cable including a conductor, a first insulation covering the conductor, and a second insulation covering the first insulation. The second insulation may include a first polymer layer and a first metallic layer coupled to the first polymer layer.

### TECHNICAL FIELD

Some implementations relate to downhole power cabling. More specifically, some implementations relate to lead free down hole power cabling.

### BACKGROUND

Power cables may be used to power equipment downhole in oil and gas environments and may have complex structures designed for reliable operation in extreme environments. These cables may be designed to withstand the harsh conditions found in wellbores, including high temperatures, pressures, and exposure to corrosive environment. The power cables may provide power to electrical submersible pumps in artificial lift systems. They also may be used to power permanent Downhole Monitoring Systems (PDHMS) for data transmission for sensors and monitoring equipment. They also may be integrated with coiled tubing systems to deliver power to downhole tools.

In some instances, these cables must withstand high temperatures, often exceeding 200° C., common in deep wells. They also may need to be capable of operating at high pressures, sometimes in excess of 20,000 psi as seen in HPHT wells. They may need to be strong to endure mechanical stresses during installation and operation. They also may need to fullfil electrical requirements related to electrical conductivity, insulation and reliability. Also, they may need to be resistant to corrosive substances such as hydrogen sulfide (H₂S) and carbon dioxide (CO₂) present in well environments.

Cable conductors are typically made from copper or aluminum. Commonly used cable insulation materials includes ethylene propylene diene monomer (EPDM) synthetic rubber, high-temperature materials such as cross-linked polyethylene (XLPE), ethylene propylene rubber (EPR), or polytetrafluoroethylene (PTFE). A metallic armor often made from a 50% lapped stainless steel tape, or other corrosion-resistant materials such as Monel, protects against physical damage and enhances mechanical strength. Lead is a robust barrier providing resistance to many corrosive chemicals with long term stability and fexibility. While lead may be a suiable material for protecting downhole cabling, it also may suffer from drawbacks related to its toxicity and relatively heavy weight. Lead is a persistent poluant and its exposure can have serious consequences, especially for vurnerable populations. Phasing out the use of lead and developing lead free alternatives are part of the efforts to reduce lead exposure and associated ecological risks.

### BRIEF DESCRIPTION OF THE DRAWINGS

Implementations of the disclosure may be better understood by referencing the accompanying drawings.

FIG. 1 is a diagram showing a cross-sectional view of a flat cable.

FIG. 2 is a diagram showing two layers of the main electric insulation.

FIG. 3 is a diagram showing an isometric view of the flat cable.

FIG. 4 is a diagram showing an isometric view of the flat cable.

FIG. 5 is a diagram showing a cross sectional view of a three-core symmetrical cable.

FIG. 6 is a diagram showing a cross-sectional view of a conductor enveloped in insulation.

FIG. 7 is a diagrammatic illustration of an example well system with an electrical submersible pump (ESP).

FIG. 8 is a flow diagram showing operations for constructing a downhole power cable.

### DESCRIPTION OF IMPLEMENTATIONS

The description that follows may include example systems, methods and techniques that embody implementations of the disclosure. However, this disclosure may be practiced without these specific details. For clarity, some well-known instruction instances, protocols, structures, and techniques may not be shown in detail. It should be understood at the outset that although illustrative implementations of one or more embodiments are illustrated below, the disclosed systems and methods may be implemented using any number of techniques, whether currently known or not yet in existence. The disclosure should in no way be limited to the illustrative implementations, drawings, and techniques illustrated below, but may be modified within the scope of the appended claims along with their full scope of equivalents.

### Overview

Some implementations eliminate lead from downhole cables. Eliminating lead from the cables may eliminate toxicity and cable weight issues associated with lead high density. Finding metals with chemical resistance and flexibility comparable to lead involves considering materials that can withstand similar corrosive environments, particularly those involving hydrogen sulfide (H₂S), carbon dioxide (CO₂), saltwater, and hydrocarbons. Some metals and alloys offer significant resistance to H₂S, to make them suitable for use in environments where H₂S is present. Selecting the appropriate material depends on specific application requirements, including mechanical properties, temperature conditions, and economic considerations. While lead is traditionally used for its chemical resistance, some implementations may provide similar or better performance in corrosive environments. For example, the following materials may provide similar or better performance than lead:
Titanium (Ti): Resistance to a wide range of corrosive environments, including seawater, chlorides, and acids.
Tantalum (Ta): Highly resistant to most acids, including hydrochloric and sulfuric acids.
Inconel (Nickel-Chromium Alloys): Resistant to oxidation and corrosion at high temperatures.
Monel (Nickel-Copper Alloys): Highly resistant to seawater and various acids and alkalis.
Hastelloy (Nickel-Molybdenum-Chromium Alloys): Resistant to severe oxidizing and reducing environments.
316 Stainless Steel: Known for its resistance to chlorides and marine environments.
904L Stainless Steel: High resistance to sulfuric and phosphoric acids.
Zirconium (Zr): Outstanding resistance to a variety of corrosive agents, including strong acids.
Platinum (Pt): Highly resistant to chemical attack, including by acids and bases.
Gold (Au): Inert to most chemicals, does not tarnish or corrode easily.

Some implementations use a plating process of the cable insulation with an appropriate metal to eliminate lead from the cable. This may simplify construction of the cable. Also, removal of the toxic lead traditionally used in down hole applications may contribute to environmental sustainability. Furthermore, the weight and size of the cable may be significantely reduced. In electrical submersible pumps (ESPs), the reduction cable size may allow more space in the annulus for produced fluid and may reduce the potential for cable damage during installation. The reduction in cable weight may significantly reduce costs for transport and deployment of the cables.

### Example Implementations

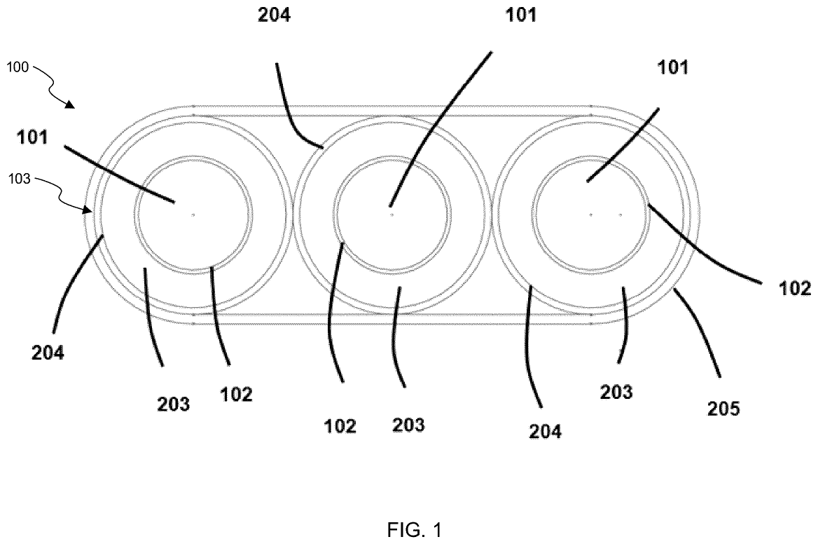

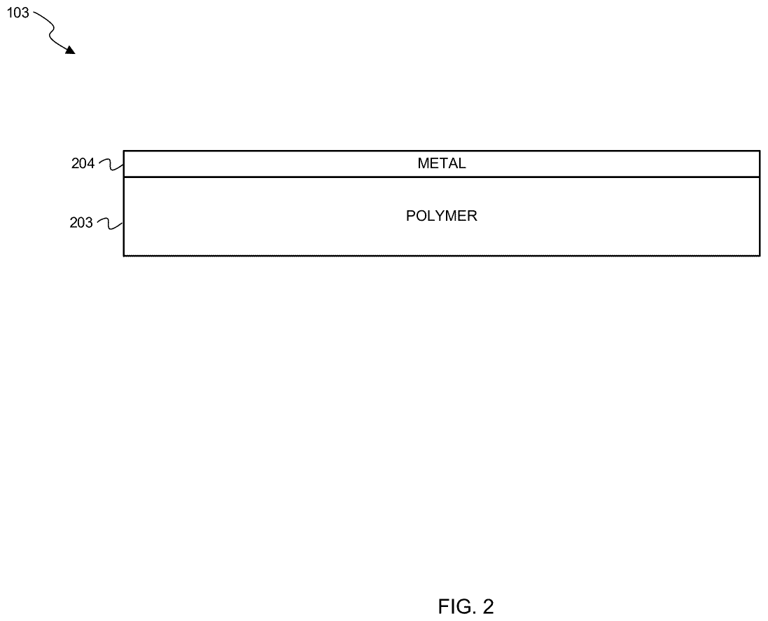

FIG. 1 is a diagram showing a cross-sectional view of a flat cable. The flat cable 100 may be suitable for providing power to an ESP or other downhole device. The flat cable 100 may include three conductors 101. The conductors 101 may include copper or other material suitable for conducting electricity to downhole components. The flat cable 100 also may include a primary electrical insulation 102 (such as a film type insulation), main electrical insulation, and an armor 205. The main electrical insulation 103 may include two layers—a polymer layer 203 and a metal layer 204. FIG. 2 is a diagram showing two integrated layers of the cable's main electric insulation. As shown, the cable's main electric insulation 103 may include a polymer layer 203 and a metallic layer 204. The polymer layer 203 may include an extruded insulation such as Ethylene Propylene Diene Monomer (EPDM). The metallic layer 204 may plated on the polymer layer 203. Some implementations may include one or more additional metallic layers such an additional metallic layer (not shown) that may be fuse bonded (or otherwise coupled) to the metallic layer 204. Yet additional metallic layers may be added, where each additional metallic layer adheres to the previous metallic layer. The metallic layer 204 (and additional metallic layers) may include one or more of the following:
Titanium (Ti): Resistance to a wide range of corrosive environments, including seawater, chlorides, and acids.
Tantalum (Ta): Highly resistant to most acids, including hydrochloric and sulfuric acids.
Inconel (Nickel-Chromium Alloys): Resistant to oxidation and corrosion at high temperatures.
Monel (Nickel-Copper Alloys): Highly resistant to seawater and various acids and alkalis.
Hastelloy (Nickel-Molybdenum-Chromium Alloys): Resistant to severe oxidizing and reducing environments.
316 Stainless Steel: Known for its resistance to chlorides and marine environments.
904L Stainless Steel: High resistance to sulfuric and phosphoric acids.
Zirconium (Zr): Outstanding resistance to a variety of corrosive agents, including strong acids.
Platinum (Pt): Highly resistant to chemical attack, including by acids and bases.
Gold (Au): Inert to most chemicals, does not tarnish or corrode easily.

In some implementations, the metallic material is deposited (for example, as a coating as a result of a plating process) on the polymer layer without using an external electrical power source. Such implementations may utilize a chemical reaction to deposit the metallic material on the polymer layer 203 to form the cable's main electrical insulation 103. In some implementations, the metallic layer 204 has uniform thickness. In some implementations, the metallic layer 204 is coupled with a suitable material other than a polymer material.

In some implementations, the cable's main electrical insulation 103 is first constructed and then installed over the cable's main electrical insulation 103 and conductor 101. However, in some implementations, the polymer layer 203 may first be installed to the primary electrical insulation 102 and then the metallic layer 204 may be added to the polymer layer 203 (such as after the polymer layer 203 has been installed on the primary electrical insulation 102 and conductor 101).

When compared to traditional flat cables that include lead, the flat cable 100 may have smaller size and lower weight. In some instances, the main electrical insulation 103 may be smaller (such as having smaller diameter) and lighter than traditional electrical insulation that includes lead. Additionally, the flat cable 100 is lead-free and may be less toxic than traditional flat cables that include lead. By reducing the diameter of the main electrical insulation 103, the armor 205 also may have smaller dimensions. Hence, the overall dimensions of the flat cable 100 may be smaller than traditional flat cables.

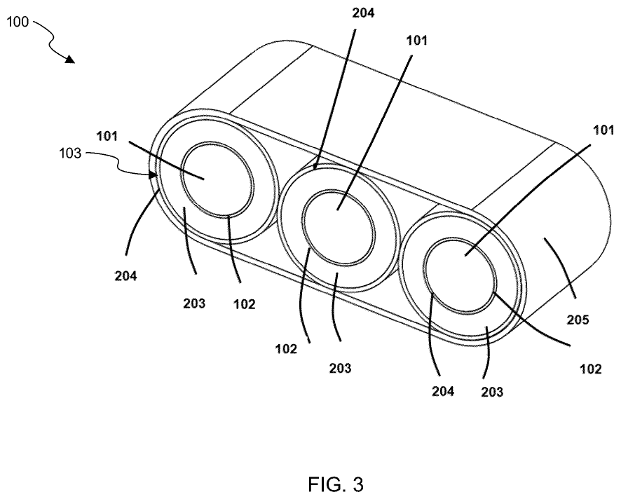

FIG. 3 is a diagram showing an isometric view of the flat cable 100.

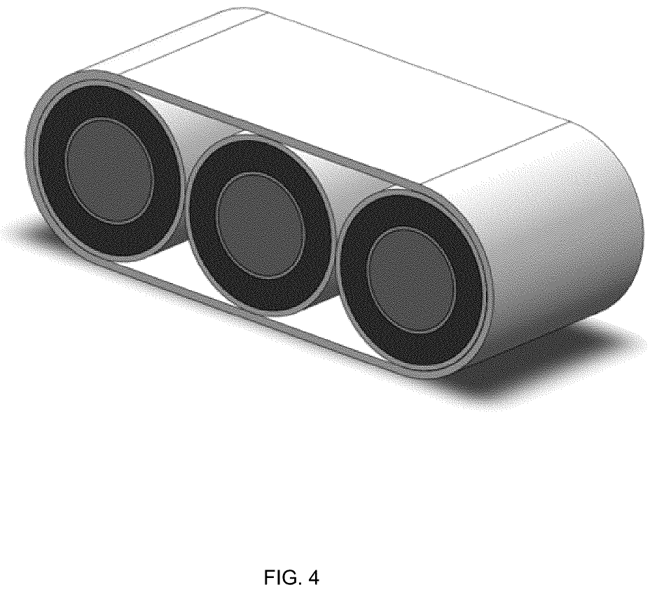

FIG. 4 is a diagram showing an isometric view of the flat cable 100.

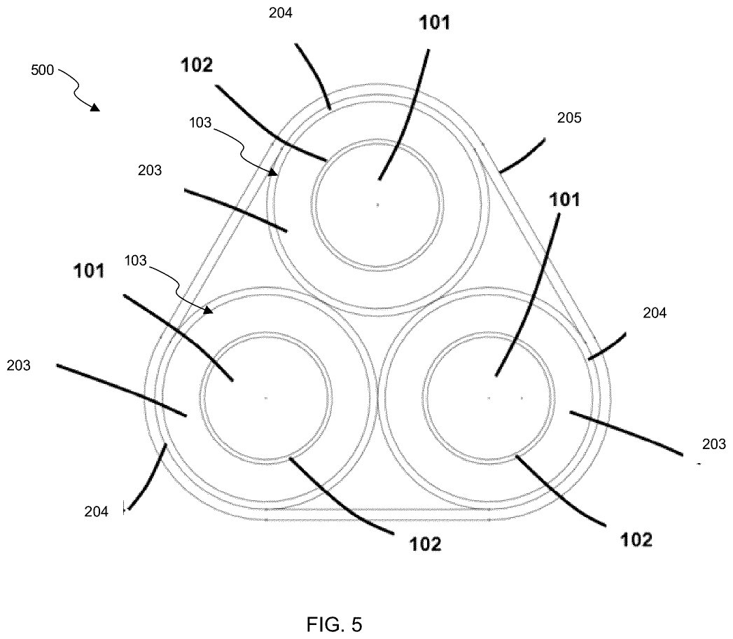

FIG. 5 is a diagram showing a cross-sectional view of a three-core symmetrical cable. In FIG. 5, the three-core symmetrical cable 500 includes conductors 101. Each of the conductors 101 may be enveloped in a primary electrical insulation 102 and a main electrical insulation 103. The main electrical insulation 103 may include a polymer layer 203 and a metallic layer 204 (as described in FIG. 2). The three-core symmetrical cable 500 also may include an armor layer 405.

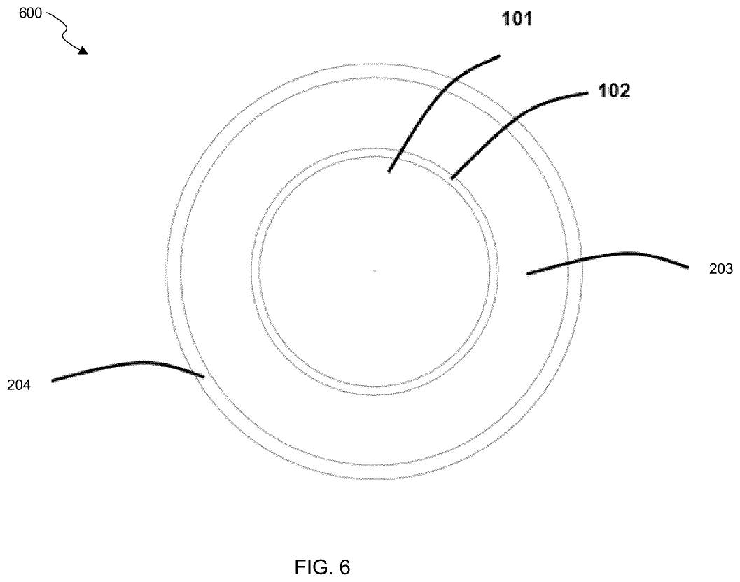

FIG. 6 is a diagram showing a cross-sectional view of a conductor enveloped in insulation. In FIG. 6, the conductor 101 is enveloped in the primary electrical insulation 102. The main electrical insulation 103 may envelop the primary electrical insulation 102. The main electrical insulation may include a polymer layer 203 and a metallic layer 204. The configuration 600 may eliminate the need for the armor 205 or other external layers. Hence, the configuration 600 may be smaller and lighter than traditional cables.

### Example Environment

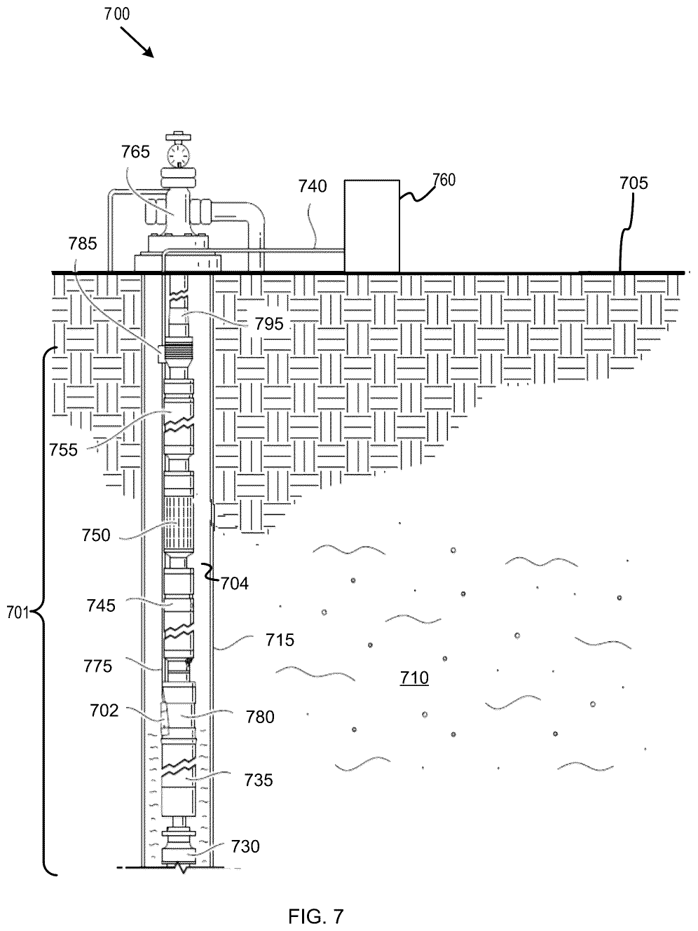

FIG. 7 is a diagrammatic illustration of an example well system with an electrical submersible pump (ESP). Any of the cables described herein (such as flat cable 100 and/or three-core symmetrical cable 500) may be used in concert with the well system 700 or any other suitable downhole system. While well system 700 illustrates a land-based subterranean environment, the present disclosure contemplates any well site environment including a subsea environment. In one or more embodiments, any one or more components or elements may be used with subterranean operations equipment located on offshore platforms, drill ships, semi-submersibles, drilling barges and land-based rigs.

An ESP assembly 701 is located downhole in a wellbore 704 below a surface 705. The wellbore 704 may, for example, be several hundred or a few thousand meters deep. The wellbore 704 is depicted as vertical, but it may also be horizontal or may be curved, bent and/or angled, depending on the wellbore direction. The wellbore 704 may be an oil well, water well, and/or well containing other hydrocarbons, such as natural gas, and/or another production fluid taken from a subsurface formation 710. The ESP assembly 701 may be separated from the subsurface formation 710 by a well casing 715. Production fluid enters the well casing 715 through casing perforations (not shown). Casing perforations may be either above or below an ESP intake 750. The ESP assembly 701 includes, from bottom to top, a downhole gauge 730 which may include one or more sensors that may detect and provide information such as motor speed, internal motor temperature, pump discharge pressure, downhole flow rate and/or other operating conditions to a user interface, variable speed drive controller, and/or data collection computer, herein individually or collectively referred to as controller 760, on surface 705. An ESP motor 735 may comprise an induction motor, such as a two-pole, three phase squirrel cage induction motor, a direct current (DC) motor, and a permanent magnet motor. An ESP cable 740 may be communicatively coupled to the controller 760. The ESP cable 740 may provide power to the ESP motor 735 and/or carries data to and/or from the downhole gauge 730 to the surface 705. A pothead 702 encloses the electrical connection between ESP cable 740 and a head 780 of the ESP motor 735. The ESP cable 740 may include any of the aspects described herein (such as the ESP cable 740 may be a flat cable 100 including the main electrical insulation 103).

In conventional ESP applications, the ESP cable 740 may extend from the controller 760 at surface 705 to a motor lead extension (MLE) 775. A cable connection 785 connects the ESP cable 740 to the MLE 775. The MLE 775 may plug in, tape in, spline in or otherwise electrically connect the ESP cable 740 to the ESP motor 735 to provide power to the ESP motor 735.

The ESP cable 740 may include a cable structure comprising superconductor material, cryogenic fluid supply channels, and cryogenic fluid return channels. In some implementations, the well system 700 may not include an MLE 775, and the ESP cable 740 may be directly electrically connected to the pothead 702. This may assist in avoiding the need to splice the superconductor cables on top of the motor. Splicing superconductor cables may be a complex procedure as it may involve both power cables and cooling channels and any other conductors in the bundle of the ESP cable 740. The well system 700 may include components (not pictured) on and/or near the surface 705 to store, pump, cool, etc. the cryogenic fluid that may be supplied to the cryogenic fluid supply channels for the superconducting cable and receive the cryogenic fluid from the cryogenic fluid return channels.

Upstream of the ESP motor 735 is a motor protector 745, an ESP intake 750, an ESP pump 755 and a production tubing 795. The motor protector 745 may serve to equalize pressure and keep the motor oil separate from well fluid. The ESP intake 750 may include intake ports and/or a slotted screen and may serve as the intake to the ESP pump 755. The ESP pump 755 may comprise a multi-stage centrifugal pump including stacked impeller and diffuser stages.

Other components of ESP assemblies may also be included in the ESP assembly 701, such as a tandem charge pump (not shown) or gas separator (not shown) located between the ESP pump 755 and the ESP intake 750 and/or a gas separator that may serve as the pump intake. Shafts of the ESP motor 735, the motor protector 745, the ESP intake 750 and the ESP pump 755 may be connected (i.e., splined) and rotated by the ESP motor 735. The production tubing 795 may carry lifted fluid from the discharge of the ESP pump 755 toward a wellhead 765.

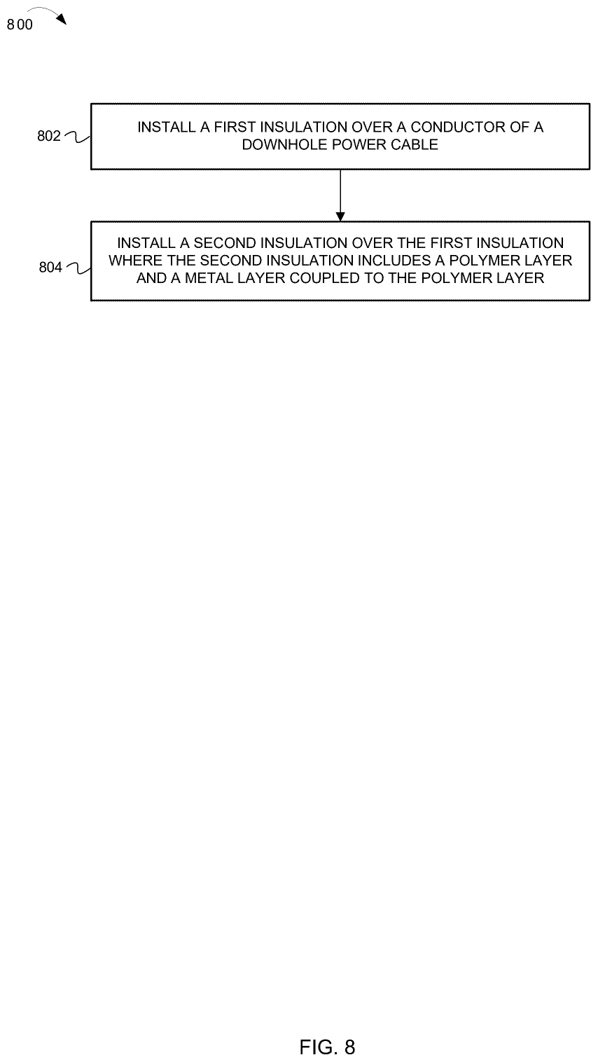

FIG. 8 is a flow diagram showing operations for constructing a downhole power cable. At block 802, a first insulation is installed over a conductor of a downhole power cable. At block 803, a second insulation is installed over the first insulation, where the second insulation includes a polymer layer, and a metallic layer coupled to the polymer layer.

### Example Clauses

Some example implementations may include the following clauses.

Clause 1: A downhole electrical cable comprising: a conductor; a first insulation covering the conductor; and a second insulation covering the first insulation, the second insulation including a first polymer layer, and a first metallic layer coupled to the first polymer layer.

Clause 2: The downhole electrical cable of clause 1, wherein the first metallic layer includes one or more of Titanium (Ti), Tantalum (Ta), Inconel (Nickel-Chromium Alloys), Monel (Nickel-Copper Alloys), Hastelloy (Nickel-Molybdenum-Chromium Alloys), 316 Stainless Steel, 904L Stainless Steel, Zirconium (Zr), Platinum (Pt), and Gold (Au).

Clause 3: The downhole electrical cable of any one or more of clauses 1-2, wherein the first polymer layer includes Ethylene Propylene Diene Monomer.

Clause 4: The downhole electrical cable of any one or more of clauses 1-3, wherein the first metallic layer is chemically bonded to the first polymer layer.

Clause 5: The downhole electrical cable of any one or more of clauses 1-4 further including: a second conductor covered in a third insulation that is covered in a fourth insulation that includes a second polymer layer couple to a second metallic layer.

Clause 6: The downhole electrical cable of any one or more of clauses 1-5 further including: a third conductor covered in a fourth insulation that is covered in a fifth insulation that includes a second polymer layer coupled to a second metallic layer.

Clause 7: The downhole electrical cable of any one or more of clauses 1-6 further comprising a second metal layer coupled to the first metallic layer.

Clause 8: A method for constructing a downhole electrical cable, the method comprising: installing a first insulation on a first conductor; installing a second insulation over the first insulation and the first conductor, wherein the second insulation includes a first polymer layer coupled with a second metallic layer.

Clause 9: The method of clause 8, wherein the first metallic layer includes one or more of Titanium (Ti), Tantalum (Ta), Inconel (Nickel-Chromium Alloys), Monel (Nickel-Copper Alloys), Hastelloy (Nickel-Molybdenum-Chromium Alloys), 316 Stainless Steel, 904L Stainless Steel, Zirconium (Zr), Platinum (Pt), and Gold (Au).

Clause 10: The method of any one or more of clauses 8-9, wherein the metallic material includes one or more of Titanium (Ti), Tantalum (Ta), Inconel (Nickel-Chromium Alloys), Monel (Nickel-Copper Alloys), Hastelloy (Nickel-Molybdenum-Chromium Alloys), 316 Stainless Steel, 904L Stainless Steel, Zirconium (Zr), Platinum (Pt), and Gold (Au).

Clause 11: The method of any one or more of clauses 8-10 further including: installing a third insulation on a second conductor; installing a fourth insulation over the third insulation and the second conductor, wherein the fourth insulation includes a second polymer layer coupled with a second metallic layer.

Clause 12: The method of any one or more of clauses 8-11 further including: installing a fifth insulation on a third conductor; installing a sixth insulation over the fifth insulation and the third conductor, wherein the sixth insulation includes a third polymer layer coupled with a third metallic layer.

Clause 13: A system comprising: one or more downhole tools; an electrical cable configured to provide electrical power to the one or more downhole tools, the electrical cable including a conductor; a first insulation covering the conductor; and a second insulation covering the first insulation, the second insulation including a first polymer layer and a first metallic layer coupled to the first polymer layer.

Clause 14: The system of clause 13, wherein the first metal layer includes one or more of Titanium (Ti), Tantalum (Ta), Inconel (Nickel-Chromium Alloys), Monel (Nickel-Copper Alloys), Hastelloy (Nickel-Molybdenum-Chromium Alloys), 316 Stainless Steel, 904L Stainless Steel, Zirconium (Zr), Platinum (Pt), and Gold (Au).

Clause 15: The system of any one or more of clauses 13-14, wherein the first polymer layer includes Ethylene Propylene Diene Monomer.

Clause 16: The system of any one or more of clauses 13-15, wherein the first metallic layer is chemically bonded to the first polymer layer.

Clause 17: The system of any one or more of clauses 13-16, wherein the electrical cable further includes a second conductor covered in a third insulation that is covered in a fourth insulation that includes a second polymer layer coupled to a second metallic layer.

Clause 18: The system of any one or more of clauses 13-17 further including: a third conductor covered in a fourth insulation that is covered in a fifth insulation that includes a second polymer layer coupled to a second metallic layer.

Clause 19: The system of any one or more of clauses 13-18, wherein a second metal layer is coupled to the first metallic layer.

Clause 20: The system of any one or more of clauses 13-19, wherein a second metal layer is coupled to the first metallic layer.

FIGS. 1-8 and the operations described herein are examples meant to aid in understanding example implementations and should not be used to limit the potential implementations or limit the scope of the claims. Some implementations may perform additional operations, fewer operations, operations in parallel or in a different order, and some operations differently. Some implementations may perform the operations with different components.

As used herein, a phrase referring to “at least one of” a list of items refers to any combination of those items, including single members. As an example, “at least one of: a, b, or c” is intended to cover: a, b, c, a-b, a-c, b-c, and a-b-c.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein but are to be accorded the widest scope consistent with this disclosure, the principles and the novel features disclosed herein.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described as acting in certain combinations and even initially claimed as such, one or more features from a claimed combination may in some cases be excised from the combination, and the claimed combination may be directed to a subcombination or variation of a subcombination.

What is claimed is:

1. A downhole electrical cable comprising:
a conductor;
a first insulation covering the conductor; and
a second insulation covering the first insulation, the second insulation including
a first polymer layer, and
a first metallic layer coupled to the first polymer layer.

2. The downhole electrical cable of claim 1, wherein the first metallic layer includes one or more of Titanium (Ti), Tantalum (Ta), Inconel (Nickel-Chromium Alloys), Monel (Nickel-Copper Alloys), Hastelloy (Nickel-Molybdenum-Chromium Alloys), 316 Stainless Steel, 904L Stainless Steel, Zirconium (Zr), Platinum (Pt), and Gold (Au).

3. The downhole electrical cable of claim 1, wherein the first polymer layer includes Ethylene Propylene Diene Monomer.

4. The downhole electrical cable of claim 1, wherein the first metallic layer is chemically bonded to the first polymer layer.

5. The downhole electrical cable of claim 1 further including:
a second conductor covered in a third insulation that is covered in a fourth insulation that includes a second polymer layer couple to a second metallic layer.

6. The downhole electrical cable of claim 5 further including:
a third conductor covered in a fourth insulation that is covered in a fifth insulation that includes a second polymer layer coupled to a second metallic layer.

7. The downhole electrical cable of claim 1 further comprising a second metal layer coupled to the first metallic layer.

8. A method for constructing a downhole electrical cable, the method comprising:
installing a first insulation on a first conductor;
installing a second insulation over the first insulation and the first conductor, wherein the second insulation includes a first polymer layer coupled with a second metallic layer.

9. The method of claim 8, wherein the first metallic layer includes one or more of Titanium (Ti), Tantalum (Ta), Inconel (Nickel-Chromium Alloys), Monel (Nickel-Copper Alloys), Hastelloy (Nickel-Molybdenum-Chromium Alloys), 316 Stainless Steel, 904L Stainless Steel, Zirconium (Zr), Platinum (Pt), and Gold (Au).

10. The method of claim 8 further comprising:
depositing metallic material onto the first polymer layer to form the second insulation.

11. The method of claim 10, wherein the metallic material includes one or more of Titanium (Ti), Tantalum (Ta), Inconel (Nickel-Chromium Alloys), Monel (Nickel-Copper Alloys), Hastelloy (Nickel-Molybdenum-Chromium Alloys), 316 Stainless Steel, 904L Stainless Steel, Zirconium (Zr), Platinum (Pt), and Gold (Au).

12. The method of claim 8 further including:
installing a third insulation on a second conductor;
installing a fourth insulation over the third insulation and the second conductor, wherein the fourth insulation includes a second polymer layer coupled with a second metallic layer.

13. The method of claim 12 further including:
installing a fifth insulation on a third conductor;
installing a sixth insulation over the fifth insulation and the third conductor, wherein the sixth insulation includes a third polymer layer coupled with a third metallic layer.

14. A system comprising:
one or more downhole tools;
an electrical cable configured to provide electrical power to the one or more downhole tools, the electrical cable including
a conductor;
a first insulation covering the conductor; and
a second insulation covering the first insulation, the second insulation including a first polymer layer and a first metallic layer coupled to the first polymer layer.

15. The system of claim 14, wherein the first metal layer includes one or more of Titanium (Ti), Tantalum (Ta), Inconel (Nickel-Chromium Alloys), Monel (Nickel-Copper Alloys), Hastelloy (Nickel-Molybdenum-Chromium Alloys), 316 Stainless Steel, 904L Stainless Steel, Zirconium (Zr), Platinum (Pt), and Gold (Au).

16. The system of claim 14, wherein the first polymer layer includes Ethylene Propylene Diene Monomer.

17. The system of claim 14, wherein the first metallic layer is chemically bonded to the first polymer layer.

18. The system of claim 14, wherein the electrical cable further includes a second conductor covered in a third insulation that is covered in a fourth insulation that includes a second polymer layer coupled to a second metallic layer.

19. The system of claim 14 further including:
a third conductor covered in a fourth insulation that is covered in a fifth insulation that includes a second polymer layer coupled to a second metallic layer.

20. The system of claim 14, wherein a second metal layer is coupled to the first metallic layer.
